(19) United States
(12) Patent Application Publication
(10) Pub. No.: US 2024/0190297 A1
(43) Pub. Date: Jun. 13, 2024

(54) ELECTRICAL POWER CONTROL APPARATUS AND METHOD OF CONTROLLING THE SAME

(71) Applicants: HYUNDAI MOTOR COMPANY, Seoul (KR); KIA CORPORATION, Seoul (KR); YURA CORPORATION CO.,LTD., Gyeonggi-do (KR)

(72) Inventors: Heegun YANG, Seongnam-si (KR); Kangwoo BAE, Suwon-si (KR); Chanyoung JUNG, Gyeonggi-do (KR); Boko CHOI, Chungcheongnam-do (KR)

(73) Assignees: Hyundai Motor Company, Seoul (KR); KIA CORPORATION, Seoul (KR); YURA CORPORATION CO.,LTD., Gyeonggi-do (KR)

(21) Appl. No.: 18/525,002

(22) Filed: Nov. 30, 2023

(30) Foreign Application Priority Data
Dec. 9, 2022 (KR) 10-2022-0171239

(51) Int. Cl. B60L 58/27; B60L 3/00; H01M 10/615; H01M 10/625

(52) U.S. Cl. CPC B60L 58/27; B60L 3/0046; H01M 10/615; H01M 10/625; B60L 2240/545; B60L 2240/547

(57) ABSTRACT

An electric power control apparatus may include: a power switch configured to supply power or cut off power to an electric load; a bidirectional switch configured to be connected in series with the power switch and to supply power or cut off power to the electric load; and a controller configured to turn on or turn off the power switch and the bidirectional switch, respectively.

### CROSS-REFERENCE TO RELATED APPLICATION(S)

The present application claims priority to Korean Patent Application No. 10-2022-0171239, filed on Dec. 9, 2022, the entire contents of which is incorporated herein for all purposes by this reference.

### BACKGROUND OF THE PRESENT DISCLOSURE

### Field of the Present Disclosure

The present disclosure relates to an electric power control apparatus, and more particularly, to a structure and control of switches forming the electric power control apparatus.

### DESCRIPTION OF RELATED ART

A battery is charged and discharged by internal chemical reactions of the battery. When the temperature of the battery is too low, a rate of the chemical reaction in the battery is decreased, and thus performance of charging or discharging of the battery is degraded. To prevent the degradation of the performance of the battery under the low temperature condition, a structure in which the temperature of the battery is increased by a separate heater when the temperature of the battery is lowered to a predetermined temperature or less is used.

To drive the heater (i.e., to control the temperature of the battery), an intelligent power switch (IPS) which is turned ON/OFF according to the temperature of the battery is used. That is, when the temperature of the battery is lowered below a predetermined temperature (e.g., 0° C.), the intelligent power switch (IPS) is turned on to supply electric power to the heater. When the temperature of the battery is raised above the predetermined temperature (e.g., 0° C.) by the operation of the heater, the intelligent power switch (IPS) is turned off to cut off supplying power to the heater (cutting off the overcurrent).

However, if an electrical short occurs inside the intelligent power switch (IPS), the present electrical short may cause the intelligent power switch (IPS) to be fully turned on. The full-turn-on state of the intelligent power switch (IPS) means that the intelligent power switch (IPS) lost its overcurrent cut off function. Therefore, when an electrical short occurs inside the intelligent power switch (IPS), the intelligent power switch (IPS) cannot perform the overcurrent cut off function.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to allowing an overcurrent cut off function of an intelligent power switch (IPS) to be performed by an alternative circuit even when the intelligent power switch (IPS) cannot perform the overcurrent cut off function.

According to an exemplary embodiment of the present disclosure, an electric power control apparatus may include: a power switch configured to supply power or cut off power to an electric load; a bidirectional switch configured to be connected in series with the power switch and to supply power or cut off power to the electric load; and a controller operatively connected to the power switch and the bidirectional switch and configured to turn on or turn off at least one of the power switch or the bidirectional switch, respectively.

The bidirectional switch may include two field effect transistors connected back-to-back.

The controller may turn off the bidirectional switch to cut off power supplied to the electric load when the power switch is not turned off while the controller generates a control signal to turn off the power switch.

The controller may be configured to conclude that the power switch is not turned off when an operation of the electric load continues while the controller generates the control signal to turn off the power switch.

The electric load may be a heater provided to heat the battery, and wherein the controller is configured to conclude that the power switch is not turned off when the heater continues to generate heat while the controller generates the control signal for turning off the power switch.

The controller may be configured to conclude that the power switch is not turned off when an output voltage of the power switch is detected while the controller generates the control signal to turn off the power switch.

According to another exemplary embodiment of the present disclosure, a method of controlling an electric power control apparatus may include power switch configured to supply power or cut off power to an electric load; a bidirectional switch configured to be connected in series with the power switch and to supply power or cut off power to the electric load; and a controller operatively connected to the power switch and the bidirectional switch and configured to turn on or turn off at least one of the power switch or the bidirectional switch, the method including: generating, by the controller, a control signal to turn off the power switch; and turning off, by the controller, the bidirectional switch to cut off power supplied to the electric load when the power switch is not turned off while the controller generates a control signal to turn off the power switch.

The bidirectional switch includes first and second field effect transistors connected back-to-back.

The method may further include concluding, by the controller, that the power switch is not turned off when an operation of the electric load continues while the controller generates the control signal to turn off the power switch.

The electric load may be a heater provided to heat the battery; and the method may further include concluding, by the controller, that the power switch is not turned off when the heater continues to generate heat while the controller generates the control signal for turning off the power switch.

The method may further include concluding, by the controller, that the power switch is not turned off when an output voltage of the power switch is detected while the controller generates the control signal to turn off the power switch.

According to various exemplary embodiments of the present disclosure, an electric power control apparatus may include: a power switch configured to supply power or cut off power to an electric load; a bidirectional switch configured to be connected in series with the power switch and to supply power or cut off power to the electric load; and a controller configured to turn on or turn off at least one of the power switch and the bidirectional switch, wherein the controller is configured to turn off the bidirectional switch to cut off power supplied to the electric load when the power switch is not turned off while the controller generates a control signal to turn off the power switch.

The bidirectional switch may include two field effect transistors connected back-to-back.

The controller may be configured to conclude that the power switch is not turned off when an operation of the electric load continues while the controller generates the control signal to turn off the power switch.

The electric load may be a heater provided to heat the battery; and the controller may be configured to conclude that the power switch is not turned off when the heater continues to generate heat while the controller generates the control signal for turning off the power switch.

The controller may be configured to conclude that the power switch is not turned off when an output voltage of the power switch is detected while the controller generates the control signal to turn off the power switch.

According to various exemplary embodiments of the present disclosure, an electric power control apparatus may include: a power switch configured to supply power or cut off power to a heater; a bidirectional switch including a structure in which two field effect transistors are connected back-to-back, configured to be connected in series with the power switch and to supply power or cut off power to the heater; and a controller operatively connected to the power switch and the bidirectional switch and configured to turn on or turn off at least one of the power switch or the bidirectional switch based on a temperature of the heater and an output voltage of the power switch, wherein the controller further configured to: generate a control signal to turn off the power switch in response that the controller concludes that the temperature of the heater reaches a preset temperature; and determine that the power switch is not turned off when an output voltage of the power switch is detected while the controller generates the control signal to turn off the power switch, and turn off the bidirectional switch to cut off power supplied to the heater when the power switch is not turned off while the controller generates a control signal to turn off the power switch.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an electric power control apparatus according to an exemplary embodiment of the present disclosure.

FIG. 2 is a diagram illustrating a method of controlling the electric power control apparatus according to an exemplary embodiment of the present disclosure.

FIG. 3 is a diagram illustrating a case where the electric power control apparatus in accordance with an exemplary embodiment of the present disclosure operates normally and the battery is heated.

FIG. 4 is a diagram illustrating a state in which power supplied to the heater is cut off by turning off the intelligent power switch of the electric power control apparatus according to the exemplary embodiment of the present disclosure.

FIG. 5 is a diagram illustrating a case in which the intelligent power switch of the electric power control apparatus according to an exemplary embodiment of the present disclosure is not operated normally due to an internal electrical short circuit.

FIG. 6 is a diagram illustrating that power supplied to the heater is cut off by turning off the bidirectional switch of the electric power control apparatus according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as disclosed herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Throughout the specification, the same reference numerals denote the same constituent elements. This specification does not describe all elements of the disclosed exemplary embodiments of the present disclosure. Furthermore, detailed descriptions of what is well known in the art or redundant descriptions on substantially the same configurations have been omitted. The terms ‘part,’ ‘module,’ ‘member,’ ‘block,’ and the like as used in the specification may be implemented in software or hardware. Furthermore, a plurality of ‘part,’ ‘module,’ ‘member,’ ‘block,’ and the like may be embodied as one component. It is also possible that one ‘part,’ ‘module,’ ‘member,’ ‘block,’ and the like includes a plurality of components.

Throughout the present specification, when one constituent element is referred to as being “connected to” another constituent element, one constituent element may be “directly connected to” the other constituent element, and one constituent element can also be “indirectly connected to” the other constituent element. The indirect connection includes a connection through a wireless communication network.

In addition, unless explicitly described to the contrary, the words “comprise,” have,” or “include” and variations, such as “comprises,” “comprising,” “has,” “having,” “includes,” or “including,” should be understood to imply the inclusion of stated constituent elements and not the exclusion of any other constituent elements.

The terms first, second, and the like are used to distinguish one component from another component, and the component is not limited by such terms described herein.

An expression used in the singular encompasses the expression of the plural, unless it includes a clearly different meaning when taken in context.

The reference numerals used in operations are used for descriptive convenience and are not intended to describe the order of operations and the operations may be performed in a different order unless otherwise stated.

Hereinafter, various embodiments of the present disclosure are described in detail with reference to the accompanying drawings.

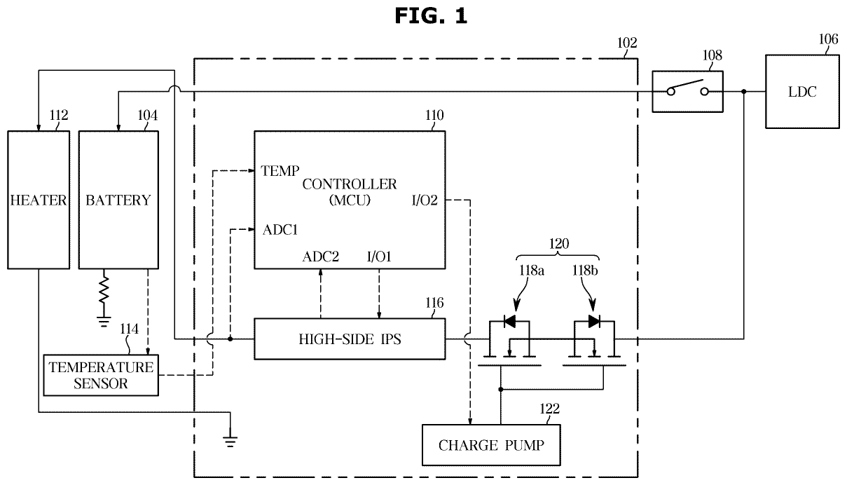

FIG. 1 is a diagram illustrating an electric power control apparatus according to an exemplary embodiment of the present disclosure.

As illustrated in FIG. 1, the electric power control apparatus 102 according to an exemplary embodiment of the present disclosure includes a controller 110 and an intelligent power switch (IPS) 116, a bidirectional switch 120, and a charge pump 122.

The intelligent power switch 116 includes a protection circuit and an energy absorption circuit for protecting an electric load from overcurrent and overheating. The intelligent power switch 116 may be a high-side IPS among the high-side IPS connected to an electric power source side and the low-side IPS connected to a ground side. The intelligent power switch 116 is also referred to as an ‘Intelligent Power Device (IPD)’.

The bidirectional switch 120 includes a structure in which two field effect transistors 118a and 118b are connected back-to-back. The field effect transistor 118a of the bidirectional switch 120 allows electric power supplied from a low voltage DC-DC converter 106 to be transferred to the intelligent power switch 116. The low-voltage DC-DC converter 106 operates as the electric power source for supplying an electric power. Another field effect transistor 118b of the bidirectional switch 120 is provided to cut off the flow of current through the parasitic diode of the field effect transistor 118a when the inside of the intelligent power switch 116 is electrically short-circuited.

The charge pump 122 is provided to turn on or off the field effect transistors 118a and 118b of the bidirectional switch 120 in response to a control signal generated from the controller 110. The charge pump 122 is a boost circuit that generates a voltage higher than the supply voltage and drives the field effect transistors 118a and 118b of the bidirectional switch 120.

The electric power control apparatus 102 is connected to a heater 112 and a temperature sensor 114, the low-voltage DC-DC converter 106 and a charging switch 108.

The heater 112 is provided to heat a battery 104. When the temperature of the battery 104 is lowered below a predetermined temperature (e.g., 0° C.), electric power is supplied from the low-voltage DC-DC converter 106 to the heater 112 through the intelligent power switch 116 and the bidirectional switch 120 of the electric power control apparatus 102. By the present power supply, the battery 104 may be heated by the heater 112.

The temperature sensor 114 is provided to detect a temperature of the battery 104. The temperature information of the battery 104 detected by the temperature sensor 114 is provided to the controller 110 of the electric power control apparatus 102.

The low-voltage DC-DC converter 106 converts a DC voltage supplied from the front end of the low-voltage DC-DC converter 106 into a DC voltage suitable for charging the battery 104. The DC voltage converted by the low voltage DC-DC converter 106 is transferred to the battery 104 through the turned-on charging switch 108. Accordingly, the battery 104 is charged.

The controller 110 of the electric power control apparatus 102 is provided to control the overall operation of the electric power control apparatus 102. For example, controller 110 is configured to control the intelligent power switch 116 and the charge pump 122 so that heating of the battery 104 using the heater 112 may be performed normally.

To the present end, the temperature information of the battery 104 detected by the temperature sensor 114 is input to the controller 110 (TEMP).

Also, magnitude information of the output voltage of the intelligent power switch 116 is input to the controller 110 (ADC1). The controller 110 may be configured to determine whether power is supplied to the heater 112 or not from the magnitude information of the output voltage of the intelligent power switch 116.

Furthermore, magnitude information of an internal voltage of the intelligent power switch 114 is input to the controller 110 (ADC2).

A signal output from an I/O1 terminal of the controller 110 is a control signal for turning on or off the intelligent power switch 116.

A signal output from an I/O2 terminal of the controller 110 is a signal for controlling the charge pump 122. That is, the field effect transistors 118a and 118b of the bidirectional switch 120 are turned on or off by the signal output from the I/O terminal of the controller 110.

The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip.

At least one component may be added or removed in accordance with the performance of the components of the vehicle shown in FIG. 1. Furthermore, it will be readily understood by those skilled in the art that the mutual positions of the components may be changed in accordance with the performance or structure of the system.

Meanwhile, each component shown in FIG. 1 refers to a software and/or hardware component such as a field programmable gate array (FPGA) and an application specific integrated circuit (ASIC).

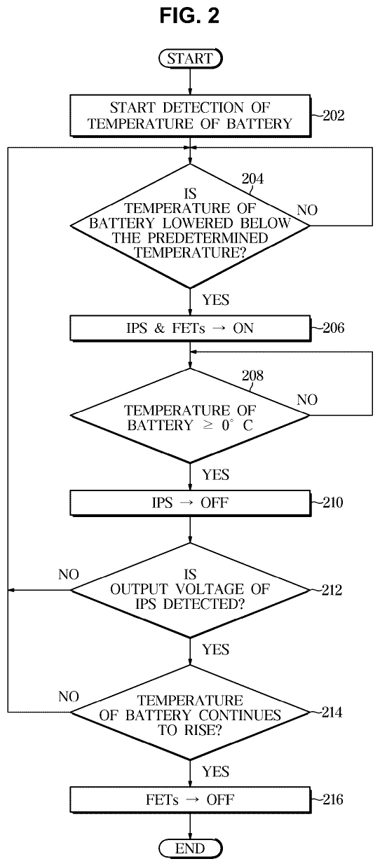

FIG. 2 is a diagram illustrating a method of controlling the electric power control apparatus according to an exemplary embodiment of the present disclosure. The method for controlling the electric power control apparatus 102 shown in FIG. 2 may be performed based on the device configuration shown in FIG. 1.

As shown in FIG. 2, the method of controlling the electric power control apparatus 102 in accordance with the exemplary embodiment of the present disclosure may start with the controller 110 of the electric power control apparatus 102 detecting the temperature of the battery 104 (202). At the instant time, DC voltage output from the low-voltage DC-DC converter 106 may be transferred to the battery 104 through the turned-on charging switch 108 to charge the battery 104.

While the controller 110 of the electric power control apparatus 102 monitors the temperature of the battery 104, the controller 110 of the electric power control apparatus 102 is configured to determine whether the temperature of the battery 104 is lowered below the predetermined temperature (e.g., 0° C.) (204).

If the temperature of the battery 104 is lowered below the predetermined temperature (e.g., 0° C.), the controller 110 of the electric power control apparatus 102 turns on the intelligent power switch 116 and the bidirectional switch 112 to supply power to the heater 112 (206). As a result, the DC voltage output from the low-voltage DC-DC converter 106 is transmitted to the heater 112 through the intelligent power switch 116 and the bidirectional switch 120 turned on, so that the heater 112 may heat up.

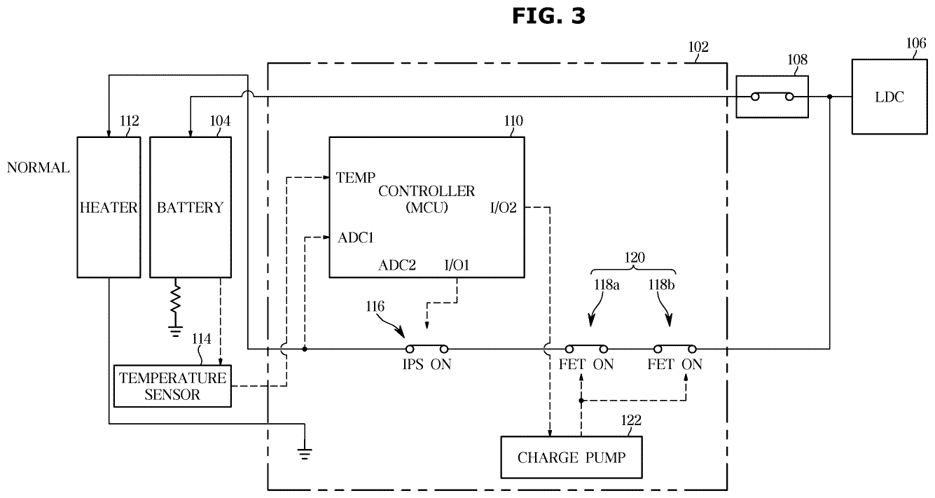

FIG. 3 is a diagram illustrating a case where the electric power control apparatus in accordance with an exemplary embodiment of the present disclosure operates normally and the battery is heated. As illustrated in FIG. 3, as the charging switch 108, the intelligent power switch 116, and the bidirectional switch 120 are all turned on, DC voltage output from the low-voltage DC-DC converter 106 is normally transferred to the battery 104 and the heater 112 so that the battery 104 may be charged heated normally.

Return to FIG. 2, the controller 110 of the electric power control apparatus 102 is configured to determine whether the temperature of the battery 104 is raised above the predetermined temperature (e.g., 0° C.) (208).

If the temperature of the battery 104 is raised by the heating of the heater 112 to above the predetermined temperature (e.g., 0° C.) (YES in 208), the controller 110 of the electric power control apparatus 102 stops heating the battery 104 by turning off the intelligent power switch 116 to cut off the power supply to the heater 112.

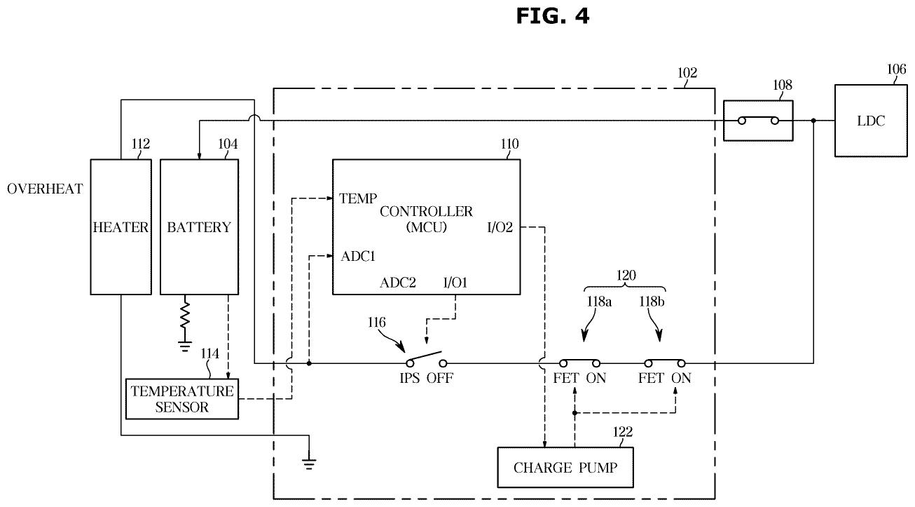

FIG. 4 is a diagram illustrating a state in which power supplied to the heater is cut off by turning off the intelligent power switch of the electric power control apparatus according to the exemplary embodiment of the present disclosure. As illustrated in FIG. 4, when the intelligent power switch 116 is turned off, DC voltage output from the low-voltage DC-DC converter 106 is not transferred to the heater 112, and thus heat generation of the heater 112 is stopped, and the battery 104 is no longer heated.

Return to FIG. 2, if the output voltage of the intelligent power switch 116 is still detected high (e.g., higher than 0V) even though the controller 110 of the electric power control apparatus 102 turns off the intelligent power switch 116 to cut off power supplied to the heater 112, the control unit 110 is configured to determine that power cut off function of the intelligent power switch 116 is not normally performed. For example, the intelligent power switch 116 may have lost its overcurrent cut off function due to an electrical short-circuit inside the intelligent power switch 116.

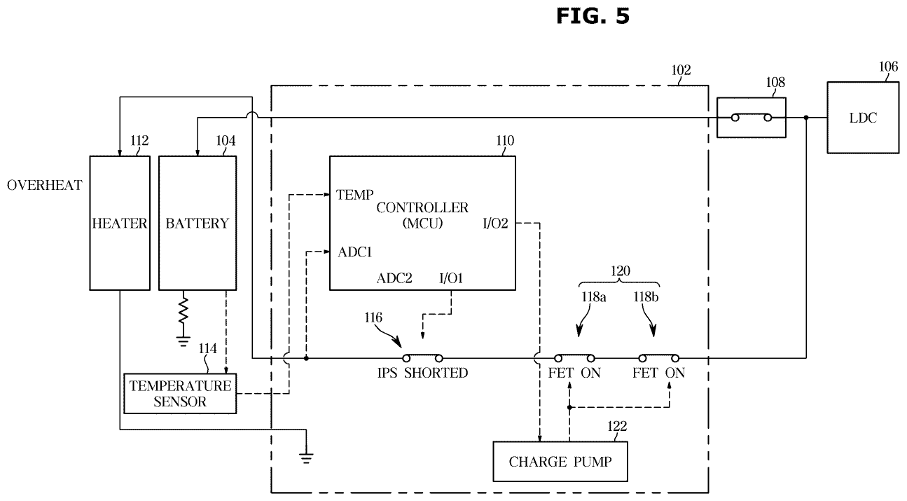

FIG. 5 is a diagram illustrating a case in which the intelligent power switch of the electric power control apparatus according to an exemplary embodiment of the present disclosure is not operated normally due to an internal electrical short circuit. As illustrated in FIG. 5, when the power cut off function is not operated due to the electrical short circuit inside the intelligent power switch 116 even though the controller 110 of the electric power control apparatus 102 turns off the intelligent power switch 116 by the control signal of I/O1 terminal, the intelligent power switch 116 is substantially the same as turned on. In the instant case, because the power supplied to the heater 112 is not cut off, the heating of the heater 112 continues, and thus the temperature of the battery 104 may be raised more than necessary.

Return to FIG. 2, if the output voltage of the intelligent power switch 116 is still detected high (e.g., higher than 0V) (YES in 212) and the temperature of the battery 104 continues to rise (YES in 214), the controller 110 of the electric power control apparatus 102 is configured to determine that the intelligent power switch 116 is not operating normally, and turns off the bidirectional switch 120 to prevent the DC voltage output from the low-voltage DC-DC converter 106 from being transmitted to the heater 112 (216).

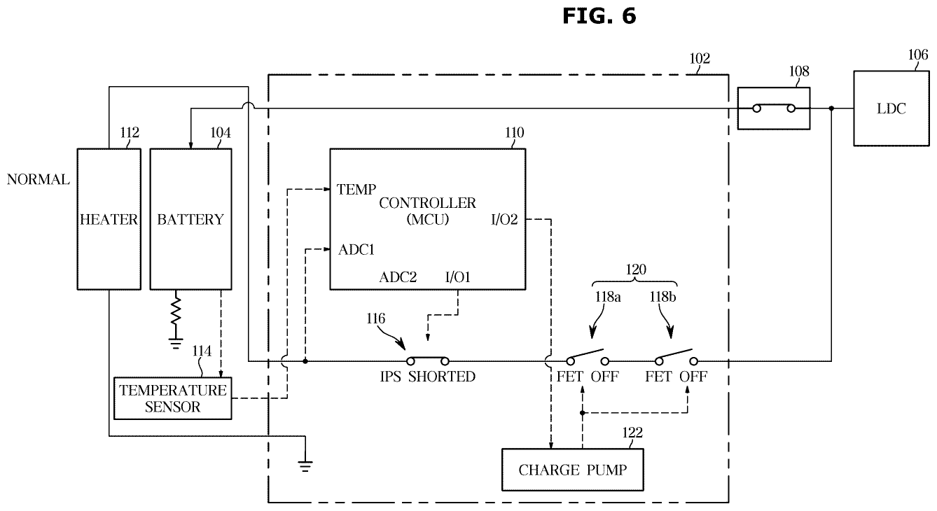

FIG. 6 is a diagram illustrating that power supplied to the heater is cut off by turning off the bidirectional switch of the electric power control apparatus according to an exemplary embodiment of the present disclosure. As illustrated in FIG. 6, when the intelligent power switch 116 fails to perform the normal power cut off function due to the internal electrical short circuit, etc., the controller 110 of the electric power control apparatus 102 may turn off both of the field effect transistors 180a and 180b of the bidirectional switch 120. In the electric power control apparatus 102 according to the exemplary embodiment of the present disclosure, because the field effect transistors 180a and 180b forming the bidirectional switch 120 are back-to-back connected to each other, a current flow generated by a parasitic diode of the turned-off field effect transistor 180a may be cut off by another turned-off field transistor 180b. Therefore, compared to the case where only one field effect transistor 180a is used alone, the bidirectional switch 120 of the present disclosure, in which two field effect transistors 180a and 180b are connected back-to-back, can perform a more reliable power cut off function.

The exemplary embodiment of the present disclosure allows an overcurrent cut off function of an intelligent power switch (IPS) to be performed by an alternative circuit even when the intelligent power switch (IPS) cannot perform the overcurrent cut off function.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system.

Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of at least one of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electric power control apparatus comprising:
a power switch configured to supply or cut off power to an electric load;
a bidirectional switch connected to the power switch in series, and supply or cut off the power to the electric load; and
a controller operatively connected to the power switch and the bidirectional switch and configured to turn on or turn off at least one of the power switch or the bidirectional switch.

2. The electric power control apparatus of claim 1, wherein the bidirectional switch includes first and second field effect transistors connected back-to-back.

3. The electric power control apparatus of claim 1, wherein the controller is configured to turn off the bidirectional switch to cut off the power supplied to the electric load in response that the controller concludes that the power switch is not turned off in a state that the controller generates a control signal to turn off the power switch.

4. The electric power control apparatus of claim 3, wherein the controller is configured to conclude that the power switch is not turned off when an operation of the electric load continues in the state that the controller generates the control signal to turn off the power switch.

5. The electric power control apparatus of claim 4,
wherein the electric load is a heater for heating a battery; and
wherein the controller is configured to conclude that the power switch is not turned off when the heater continues to generate heat in the state that the controller generates the control signal to turn off the power switch.

6. The electric power control apparatus of claim 5, wherein the controller is further configured to generate a control signal to turn off the power switch in response that the controller concludes that a temperature of the heater reaches a preset temperature.

7. The electric power control apparatus of claim 3, wherein the controller is configured to conclude that the power switch is not turned off when an output voltage of the power switch is detected by the controller in the state that the controller generates the control signal to turn off the power switch.

8. A method of controlling an electric power control apparatus including a power switch configured to supply or cut off power to an electric load: a bidirectional switch connected to the power switch in series and configured to supply or cut off the power to the electric load; and a controller operatively connected to the power switch and the bidirectional switch and configured to turn on or turn off at least one of the power switch or the bidirectional switch, the method comprising:
generating, by the controller, a control signal to turn off the power switch; and
turning off, by the controller, the bidirectional switch to cut off the power supplied to the electric load in response that the controller concludes that the power switch is not turned off in a state that the controller generates a control signal to turn off the power switch.

9. The method of claim 8, wherein the bidirectional switch includes first and second field effect transistors connected back-to-back.

10. The method of claim 8, further including concluding, by the controller, that the power switch is not turned off when an operation of the electric load continues in the state that the controller generates the control signal to turn off the power switch.

11. The method of claim 10,
wherein the electric load is a heater for heating a battery;
wherein the method further includes concluding, by the controller, that the power switch is not turned off when the heater continues to generate heat in the state that the controller generates the control signal to turn off the power switch.

12. The method of claim 11, wherein the controller is further configured to generate the control signal to turn off the power switch in response that the controller concludes that a temperature of the heater reaches a preset temperature.

13. The method of claim 8, further including concluding, by the controller, that the power switch is not turned off when an output voltage of the power switch is detected by the controller in the state that the controller generates the control signal to turn off the power switch.

14. An electric power control apparatus comprising:
a power switch configured to supply or cut off power to an electric load;
a bidirectional switch connected to the power switch in series and configured to supply or cut off the power to the electric load; and
a controller operatively connected to the power switch and the bidirectional switch and configured to turn on or turn off at least one of the power switch or the bidirectional switch;
wherein the controller is further configured to turn off the bidirectional switch to cut off the power supplied to the electric load in response that the controller concludes that the power switch is not turned off in a state that the controller generates a control signal to turn off the power switch.

15. The electric power control apparatus of claim 14, wherein the bidirectional switch includes first and second field effect transistors connected back-to-back.

16. The electric power control apparatus of claim 14, wherein the controller is configured to conclude that the power switch is not turned off when an operation of the electric load continues in the state that the controller generates the control signal to turn off the power switch.

17. The electric power control apparatus of claim 16,
wherein the electric load is a heater for heating a battery; and
wherein the controller is configured to conclude that the power switch is not turned off when the heater continues to generate heat in the state that the controller generates the control signal to turn off the power switch.

18. The electric power control apparatus of claim 17, wherein the controller is further configured to generate a control signal to turn off the power switch in response that the controller concludes that a temperature of the heater reaches a preset temperature.

19. The electric power control apparatus of claim 14, wherein the controller is configured to conclude that the power switch is not turned off when an output voltage of the power switch is detected by the controller in the state that the controller generates the control signal to turn off the power switch.

20. An electric power control apparatus comprising:
a power switch configured to supply or cut off power to a heater;
a bidirectional switch including first and second field effect transistors connected back-to-back, and connected to the power switch in series to supply or cut off the power to the heater; and
a controller operatively connected to the power switch and the bidirectional switch and configured to turn on or turn off at least one of the power switch or the bidirectional switch, respectively based on a temperature of the heater and an output voltage of the power switch;
wherein the controller is further configured to:
generate a control signal to turn off the power switch in response that the controller concludes that the temperature of the heater reaches a preset temperature; and
conclude that the power switch is not turned off when the output voltage of the power switch is detected by the controller in a state that the controller generates the control signal to turn off the power switch, and turn off the bidirectional switch to cut off the power supplied to the heater.
